(19) United States
(12) Patent Application Publication
(10) Pub. No.: US 2025/0001555 A1
(43) Pub. Date: Jan. 2, 2025

(54) Apparatus for Cutting a Fishing Line

(71) Applicant: Toit Fishing Limited, Hartford (GB)

(72) Inventor: Warren Shawn du Toit, Hartford (GB)

(21) Appl. No.: 18/747,644

(22) Filed: Jun. 19, 2024

(30) Foreign Application Priority Data
Jun. 28, 2023 (GB) 2309765.2

(51) Int. Cl. B25B 7/22; B25B 7/08

(52) U.S. Cl. CPC B25B 7/22; B25B 7/08

(57) ABSTRACT

Apparatus (10) for cutting a fishing a fishing line comprises a first lever (12) pivotally coupled to a second lever (14) to define opposed jaws (16, 17) and corresponding handles (18, 19) for opening and closing the opposed jaws (16, 17) by relative rotation of the corresponding handles (18, 19) about a pivot axis (20). Each of the first and second levers (12, 14) comprises a respective lever body (24, 26) and a respective cutting member (30, 31). Each cutting member (30, 31) has at least one open-ended channel (32), with a cutting edge (34) at one end of the or each open-ended channel (32). Each cutting member (30, 31) is a discrete component which is formed of a harder material than the lever body (24, 26) of each lever (12, 14).

### TECHNICAL FIELD

The present invention relates to an apparatus for cutting a fishing line.

### TECHNICAL BACKGROUND

Fishing pliers are a versatile tool that can be used for a variety of tasks by fisherman, such as removing hooks, cutting fishing line, crimping leaders and swivels, and opening split rings. Fishing pliers are typically made from stainless steel, aluminum, or brass. Each material has its own advantages and disadvantages. For example, stainless steel and brass are very strong, durable and corrosion-resistant, but are also relatively dense materials. Aluminum is lightweight and corrosion resistant, but is not as strong as stainless steel and brass.

There are two main types of fishing pliers: standard pliers and needle-nose pliers. Both have opposed jaws which typically have: a first region configured to grip securely an object such as a hook; and a second region configured to cut a fishing line. The second region typically includes a pair of cutting blades which are configured to pinch and indent a fishing line from opposite sides, cutting with a wedging action rather than a shearing action. The term “fishing line” as used herein includes many different structures (ranging from monofilament to multi-stranded e.g. braided structure) and different materials (ranging from man-made materials such as nylon, fluorocarbon and DACRON, to metals such as stainless steel). In some fishing pliers, the cutting blades are made of a material which is harder than other parts of the pliers, and each may be individually mounted (e.g., with a screw) on a respective lever of the pliers for replacement in the event the cutting blade becomes blunt or damaged.

The present invention seeks to address at least some of the above issues by providing improved apparatus for cutting a fishing line.

### SUMMARY OF THE INVENTION

In accordance with a first aspect of the present invention, there is provided apparatus for cutting a fishing line, comprising: a first lever pivotally coupled to a second lever to define opposed jaws and corresponding handles for opening and closing the opposed jaws by relative rotation of the corresponding handles about a pivot axis, with each lever comprising a lever body and a cutting member defining: an open-ended channel; and a cutting edge at one end of the open-ended channel, wherein the open-ended channels of the cutting members are registrable end to end when the handles are in a first configuration, and offset when the handles are rotated relative to each other about the pivot axis from the first configuration to a second configuration, and wherein the cutting edges of the cutting members are configured to cut with a shearing action a length of fishing line received in the open-ended channels as the handles rotate from the first configuration to the second configuration, characterized in that each of the cutting members is a discrete component which is formed of a harder material than the lever body of each lever.

As a discrete component, each cutting member is a separate part to the lever body of its respective lever. As such, each cutting member may be configured to provide improved cutting performance, for example to help maintain the integrity of each cutting edge during use, and independently of the design constraints and/or considerations on the lever body of each lever. Additionally or alternatively, the lever body of each lever may be made of a less dense material and/or a more corrosion resistant and/or a more impact resistant material than the cutting members. For example, each cutting member may comprise hardened steel or tungsten carbide, and each lever body may comprise aluminium.

Registering the open-ended channels of the cutting members end to end when the handles are in the first configuration forms a continuous open-ended channel for receiving therein a length of fishing line. The open-ended channels may be open-topped, open-ended channels, enabling the length of fishing line to be introduced into the continuous open-ended channel through its open top (rather than inserted into the continuous open-ended channel via an open end thereof). Subsequently moving the handles to the second configuration, offsets the open-ended channels (with one moving in a circumferential direction about the pivot axis relative to the other), enabling the cutting edges to slide over and past each other to cut the length of fishing line with a shearing action. The cutting edges may extend at least partially in a radial direction away from the pivot axis. In the first configuration, the opposed jaws may be open; and in the second configuration, the opposed jaws may be closed.

The cutting members may be disposed in a region of the apparatus between the opposed jaws and the corresponding handles. For example, the cutting members may be disposed adjacent the pivot axis. The cutting members may even at least partially surround the pivot axis. At least one cutting member may have a substantially annular cross section and/or a substantially annular end face, with the pivot axis extending through a centre of the substantially annular cross section and/or the substantially annular end face.

Each cutting member may be held in position between the lever bodies at least in part by a fulcrum pin pivotally coupling the first lever to the second lever. The fulcrum pin may urge opposed surfaces of the cutting members together, and may ensure the opposed surfaces abut to encourage a high quality shearing action as the handles rotate from the first configuration to the second configuration. In this way, the abutting opposed surfaces of the cutting members act as mating faces of the apparatus, rather than the lever bodies, as the handles rotate between the first and second configurations. Each cutting member may have an aperture extending therethrough and through which the fulcrum pin extends. For example, each cutting member may be substantially disc-shaped, and the aperture may have a longitudinal axis which is co-axial with the pivot axis. The fulcrum pin may be releasable, and each cutting member may be detachably mounted on the lever body of its respective lever. Such an arrangement enables the cutting members to be replaced if the cutting edges become blunt or damaged.

Each cutting member may be mounted (e.g. detachably mounted) in a recess on the lever body of its respective lever. The recess may be formed in a surface of the lever body which faces the corresponding lever. In this way, the lever bodies may help to shield the cutting members from accidental damage, e.g. impact damage if the apparatus is dropped on to a hard surface. Each cutting member may be received in its respective recess in such a way that the open-ended channels of the cutting members are in a predetermined position and orientation relative to the pivot axis. For example, the cutting members and the recesses may have corresponding profiles which inter-engage when the cutting members are in the predetermined position and orientation relative to the pivot axis.

The open-ended channels of the cutting members may be spaced radially from the pivot axis. When the open-ended channels are registered, with the handles in the first configuration, the open-ended channels may be disposed to one side of the apparatus between the jaw of one lever and the handle of the other lever. In other words, when the open-ended channels are registered, with the handles in the first configuration, the open-ended channels may be disposed outside of the opposed jaws (i.e. not within an acute angle formed at the pivot axis between the opposed jaws), and may be disposed outside of the corresponding handles (i.e. not within an acute angle formed at the pivot axis between the corresponding handles). Of course, other arrangements are possible, for example the open-ended channels may be disposed between the jaws, or even between the handles, when the handles are in in the first configuration.

Open ends of each of the open-ended channels may be spaced in a direction substantially parallel to the pivot axis.

At least one cutting edge may be serrated.

The opposed jaws may be configured to grip an object placed therebetween in use when a user applies a force to the corresponding handles, urging the handles to rotate towards one another about the pivot axis. In other words, the apparatus may be configured as a pair of pliers, e.g. fishing pliers. Of course, other arrangements are possible, and for example the opposed jaws may be configured to cut, rather than grip.

A resilient spring may be disposed between the cutting members, and may for example be disposed around the pivot axis. The resilient spring may bias the levers to urge the handles to rotate away from one another about the pivot axis. For example, the resilient spring may bias the levers to urge the handles to rotate from the second configuration to the first configuration absent an external load. In this way, a user may be required to apply a force to overcome bias when rotating the handles from the first configuration to the second configuration.

In accordance with another aspect of the present invention, there is provided a method of cutting a length of fishing line, comprising: providing the apparatus according to the first aspect of the present invention; registering end to end the open-ended channels of the cutting members by positioning the handles in the first configuration; introducing the length of fishing line into the open-ended channels of the cutting members when registered end to end; and rotating the handles from the first configuration to the second configuration such that the cutting edges of the cutting members cut with a shearing action the length of fishing line.

Any of the optional features of the first aspect of the present invention may be optional features of the second aspect of the present invention.

### BRIEF DESCRIPTION OF DRAWINGS

An embodiment of the invention will now be described by way of example and with reference to the accompanying figures, in which:

FIG. 1 is a schematic perspective view of apparatus for cutting a fishing line, shown in a closed configuration, according to one embodiment of the present invention;

FIG. 2 is an exploded view showing components of one form of the apparatus of FIG. 1;

FIG. 3 is a plan view of the apparatus of FIG. 1, shown in the open configuration;

FIG. 4 is another plan view of the apparatus of FIG. 1, shown in the closed configuration; and

FIGS. 5A, 5B and 5C show respectively perspective, enlarged and cutaway detail of another form of the apparatus of FIG. 1 (with fulcrum pin removed for clarity).

### DESCRIPTION OF SPECIFIC EMBODIMENT

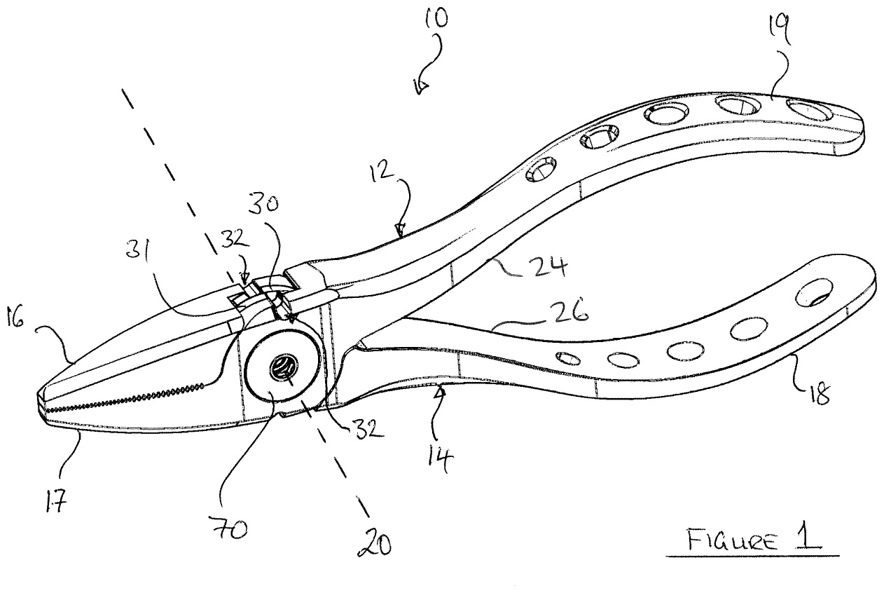

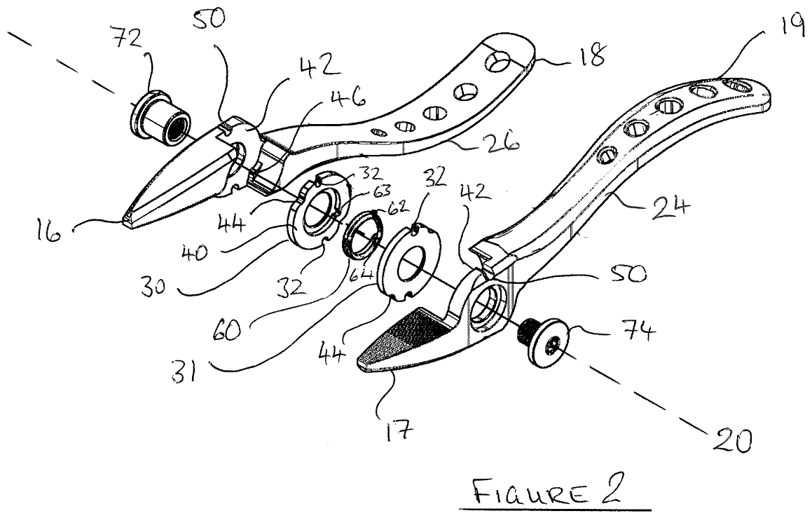

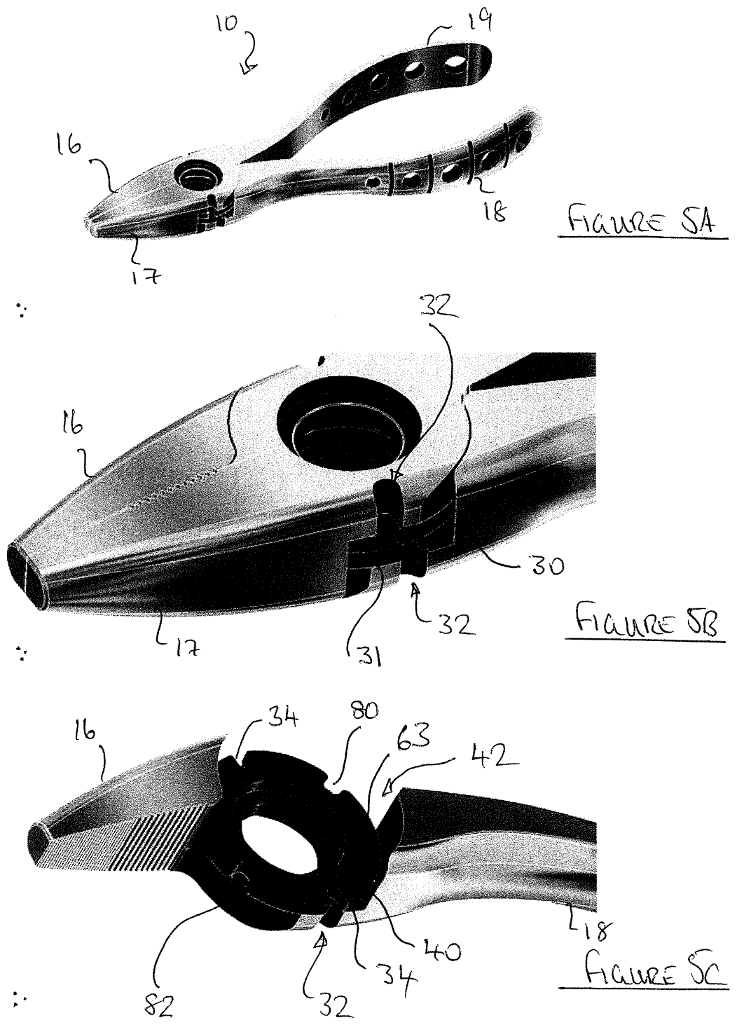

FIG. 1 illustrates schematically apparatus 10 for cutting a fishing line, in accordance with an embodiment of the present invention. The apparatus 10 comprises a first lever 12 pivotally coupled to a second lever 14 to define opposed jaws 16, 17 and corresponding handles 18, 19 for opening and closing the opposed jaws 16, 17 by relative rotation of the corresponding handles 18, 19 about a pivot axis 20. Each of the first and second levers 12, 14 comprises a respective lever body 24, 26 and a respective cutting member 30, 31 (shown in FIG. 2). Each cutting member 30, 31 has at least one open-ended channel 32, with a cutting edge 34 at one end of the or each open-ended channel 32 (see FIG. 5C). Each cutting member 30, 31 is a discrete component which is formed of a harder material than the lever body 24, 26 of each lever 12, 14.

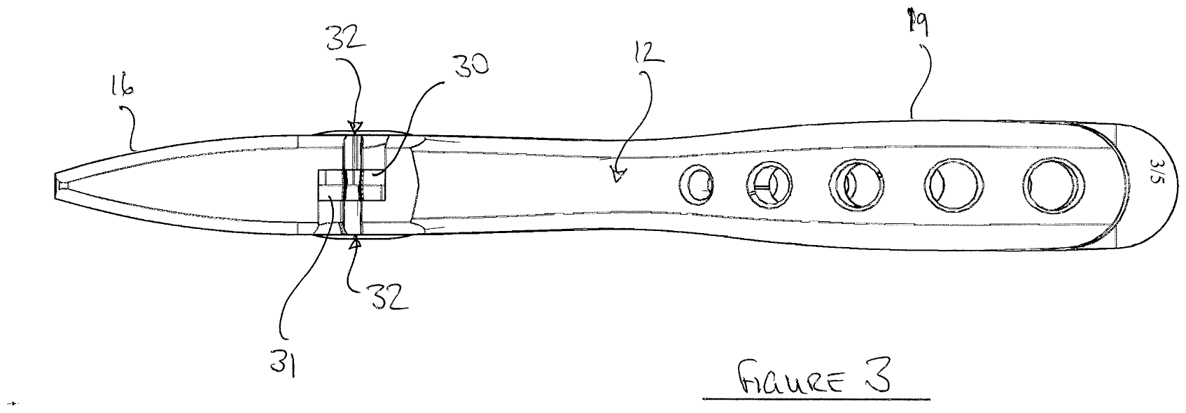

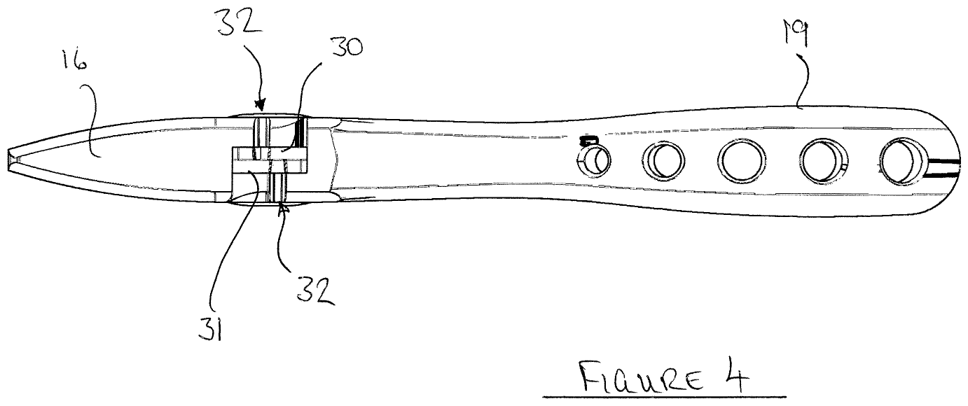

The open-ended channels 32 of the cutting members 30, 31 are registrable end to end when the handles are in a first configuration (with opposing jaws 16, 17 open) to form a continuous open-ended channel (as shown in FIG. 3) for receiving a length of fishing line (not shown) therein. Each open-ended channel 32 is also open-topped to allow the length of fishing line to be introduced into the continuous open-ended channel from above in the plan view of FIG. 3 (rather than inserted into the continuous open-ended channel via an open end thereof). The open-ended channels 32 of the cutting members 30, 31 de-register and are offset when the handles are rotated relative to each other about the pivot axis from the first configuration to a second configuration (as shown in FIG. 4), with opposing jaws 16, 17 closed as shown in FIG. 1. The cutting edges 34 of the cutting members 30, 31 are configured to cut with a shearing action a length of fishing line received in the registered open-ended channels 32 as the handles rotate from the first configuration to the second configuration.

As shown in FIG. 2, each cutting member 30, 31 has a substantially annular profile or cross section, being substantially disc-shaped with a central aperture for receiving a fulcrum pin 70 pivotally coupling the first lever 12 to the second lever 14. Each cutting member 30, 31 has opposed, substantially annular end faces 40. Each cutting member 30, 31 is mounted in a recess 42 in the lever body 24, 26 of the respective lever 12, 14, with the pivot axis 20 extending through a centre of the substantially annular cross section and annular end face 40. In the arrangement shown in FIG. 2, each cutting member 30, 31 has at least one indent 44 in its circumferential periphery for engaging a corresponding protuberance 46 in the respective recess 42 to prevent accidental rotation of the cutting member 30, 31 (relative to the recess 42) when mounted in the respective recess 42. The open-ended channels 32 register with corresponding channels 50 in the lever bodies 24, 26 of the levers 12, 14 when the cutting members 30, 31 are mounted in their respective recesses 42. The cutting members 30, 31 may comprise a harder material than other parts of the levers 12, 14.

As also shown in FIG. 2, each cutting member 30, 31 has a pair of diametrically-opposite open-ended channels 32, and a pair of diametrically-opposite indents 44. The pairs of diametrically-opposite open-ended channels 32 provide means for cutting a length of fishing line on either one side of the pivot axis 20 (e.g. upper side as shown in FIG. 1) or on another side of the pivot axis (e.g. lower side as shown in FIG. 1). The pair of diametrically-opposite indents 44 are configured to engage a pair of protuberances 46 in each recess 42 to provide greater security against accidental rotation of the cutting member 30, 31 when mounted in the respective recess 42.

A coil spring 60 is sandwiched between the cutting members 30, 31. One end 62 of the coil spring 60 engages a notch 63 in the radial inner periphery of one cutting member 30, and the other end 64 of the spring 60 engages a corresponding notch in the radial inner periphery of the other cutting member 31. In this way, relative rotation of the cutting members 30, 31 about the pivot axis 20 from a rest position results in energy being stored in the coil spring 60, exerting a bias on the cutting members 30, 31, seeking to restore the cutting members 30, 31 to the rest position. The coil spring 60 and cutting members 30, 31 are held in place about the pivot axis 20 by a fulcrum pin 70. The fulcrum pin 70 comprises a nut part 72 and a bolt part 74 which engage from opposite directions along the pivot axis 20.

FIGS. 5A, 5B and 5C show another form of the apparatus 10′ to that shown in FIG. 1. Instead of having indents 44 for engaging corresponding protuberances 46 in the respective recesses 42, the cutting members 30, 31 have apertures 80 which register with bores 82 in the recesses 42. Each bore 82 receives part of a pin or screw (not shown) which projects into the corresponding aperture 80 to prevent accidental rotation of the cutting members 30, 31 (relative to the recess 42) when mounted in their respective recess 42. Other than the way in which the orientation of each cutting members 30, 31 is maintained in its respective recess 42, the apparatus 10′ is otherwise the same as the apparatus 10 shown in FIG. 1, and therefore operates in the same way when cutting a length of fishing line.

The following additional Inventive Concepts are also provided:

Inventive Concept 1. Apparatus for cutting a fishing line, comprising: a first lever pivotally coupled to a second lever to define opposed jaws and corresponding handles for opening and closing the opposed jaws by relative rotation of the corresponding handles about a pivot axis, with each lever comprising a lever body and a cutting member defining: an open-ended channel; and a cutting edge at one end of the open-ended channel, wherein the open-ended channels of the cutting members are registrable end to end when the handles are in a first configuration, and offset when the handles are rotated relative to each other about the pivot axis from the first configuration to a second configuration, and wherein the cutting edges of the cutting members are configured to cut with a shearing action a length of fishing line received in the open-ended channels as the handles rotate from the first configuration to the second configuration, characterized in that at least one of the cutting members is a discrete component which is: (a) formed of a different material to the lever body of its respective lever; and/or (b) detachably mounted on the lever body of its respective lever.

Inventive Concept 2. Apparatus according to Inventive Concept 1 when (a) applies, wherein the discrete component comprises a harder material than the lever body of its respective lever.

Inventive Concept 3. Apparatus according to Inventive Concept 2, wherein the lever body of its respective lever comprises a less dense material and/or a more corrosion resistant and/or a more impact resistant material than the discrete component.

Inventive Concept 4. Apparatus according to any one of the preceding Inventive Concepts when (b) applies, wherein the discrete component is detachably mounted in a recess on the lever body of its respective lever.

Inventive Concept 5. Apparatus according to Inventive Concept 4, wherein the recess is formed in a surface of the respective lever body which faces the corresponding lever.

Inventive Concept 6. Apparatus according to Inventive Concept 4 or Inventive Concept 5, wherein the discrete component is received in the recess in such a way that the open-ended channel of the at least one cutting member is in a predetermined position and orientation relative to the pivot axis.

Inventive Concept 7. Apparatus according to any one of the preceding Inventive Concepts, wherein the discrete component is held in place at least in part by a fulcrum pin pivotally coupling the first lever to the second lever.

Inventive Concept 8. Apparatus according to Inventive Concept 7, wherein the discrete component is substantially disc-shaped with a central aperture for receiving the fulcrum pin.

Inventive Concept 9. Apparatus according to Inventive Concept 8 when (b) applies, wherein the fulcrum pin is releasable, and the disc-shaped discrete component has at least two open-ended channels in its circumferential periphery, each with a respective cutting edge.

Inventive Concept 10. Apparatus according to any one of the preceding Inventive Concepts, wherein the at least one cutting member is a discrete component which is: (a) formed of a different material to the lever body of its respective lever; and (b) detachably mounted on the lever body of its respective lever.

Inventive Concept 11. Apparatus according to claim 10, wherein each cutting member is a discrete component which is: (a) formed of a different material to the lever body of its respective lever; and (b) detachably mounted on the lever body of its respective lever.

### INCORPORATION BY REFERENCE

The entire content of the following document is incorporated by reference into this document: GB Pat. App. No. 2309765.2, titled “Apparatus for Cutting a Fishing Line,” filed on 28 Jun. 2023.

What is claimed is:

1. Apparatus for cutting a fishing line, comprising:
a first lever pivotally coupled to a second lever to define opposed jaws and corresponding handles structured to open and close the opposed jaws by relative rotation of the corresponding handles about a pivot axis, with each lever comprising a lever body and a cutting member defining: an open-ended channel; and a cutting edge at one end of the open-ended channel,
wherein the open-ended channels of the cutting members are registrable end to end when the handles are in a first configuration, and offset when the handles are rotated relative to each other about the pivot axis from the first configuration to a second configuration, and
wherein the cutting edges of the cutting members are configured to cut with a shearing action a length of fishing line received in the open-ended channels as the handles rotate from the first configuration to the second configuration,
wherein each of the cutting members is a discrete component which is formed of a harder material than the lever body of each lever.

2. Apparatus according to claim 1, wherein each cutting member are held in position at least in part by a fulcrum pin pivotally coupling the first lever to the second lever.

3. Apparatus according to claim 2, wherein each cutting member has an aperture extending therethrough and through which the fulcrum pin extends.

4. Apparatus according to claim 3, wherein each cutting member is substantially disc-shaped, and the aperture has a longitudinal axis which is co-axial with the pivot axis.

5. Apparatus according to claim 2, wherein the fulcrum pin is releasable, and each cutting member is detachably mounted on the lever body of its respective lever.

6. Apparatus according to claim 5, wherein each cutting member is detachably mounted in a recess on the lever body of its respective lever.

7. Apparatus according to claim 6, wherein each recess is formed in a surface of the respective lever body which faces the corresponding lever.

8. Apparatus according to claim 6, wherein each cutting member is received in the respective recess such that the open-ended channel of the at least one cutting member is in a predetermined position and orientation relative to the pivot axis.

9. Apparatus according to claim 1, wherein the lever body of each lever comprises a less dense material and/or a more corrosion resistant and/or a more impact resistant material than the cutting members.

10. Apparatus according to claim 1, where open ends of each of the open-ended channels are spaced in a direction substantially parallel to the pivot axis.

11. Apparatus according to claim 1, wherein at least one cutting edge is serrated.

12. Apparatus according to claim 1, wherein the opposed jaws are configured to grip an object placed therebetween in use.

13. Apparatus according to claim 1, further comprising a resilient spring disposed between the cutting members, the resilient spring being configured to bias the first and second levers such that the handles adopt a predetermined configuration about the pivot axis when unconstrained.

14. A method of cutting a length of fishing line, comprising:
providing apparatus comprising a first lever pivotally coupled to a second lever to define opposed jaws and corresponding handles structured to open and close the opposed jaws by relative rotation of the corresponding handles about a pivot axis, with each lever comprising a lever body and a cutting member defining: an open-ended channel; and a cutting edge at one end of the open-ended channel, wherein the open-ended channels of the cutting members are registrable end to end when the handles are in a first configuration, and offset when the handles are rotated relative to each other about the pivot axis from the first configuration to a second configuration, and wherein each of the cutting members is a discrete component which is formed of a harder material than the lever body of each lever;
registering end to end the open-ended channels of the cutting members by positioning the handles in the first configuration;
introducing the length of fishing line into the open-ended channels of the cutting members when registered end to end; and
rotating the handles from the first configuration to the second configuration such that the cutting edges of the cutting members cut with a shearing action the length of fishing line.
